(19) United States
(12) Patent Application Publication
(10) Pub. No.: US 2011/0181652 A1
(43) Pub. Date: Jul. 28, 2011

(54) PRINTING APPARATUS AND MAINTENANCE METHOD THEREOF

(75) Inventor: Shinya Komatsu, Shiojiri-shi (JP)

(73) Assignee: Seiko Epson Corporation, Tokyo (JP)

(21) Appl. No.: 13/015,002

(22) Filed: Jan. 27, 2011

(30) Foreign Application Priority Data
Jan. 27, 2010 (JP) 2010-015128

(51) Int. Cl. B41J 29/393

(52) U.S. Cl. 347/19

(57) ABSTRACT

An actual measurement value indicating an ejection state of ink ejected from nozzles is measured, the actual measurement value is compared with a first threshold value and a second threshold value which are set for each ink color to determine which is the ejection state of the ink among three states of a normal state, a clogged state, and an unstable ejection state between the normal state and the clogged state, which are distinguished by the first threshold value and the second threshold value, and different maintenance operations are performed in accordance with a determination result.

### BACKGROUND

1. Technical Field

The present invention relates to a printing apparatus and a maintenance method of the printing apparatus.

2. Related Art

JP-A-2006-142554 discloses a method of detecting the presence or absence of ink droplets ejected from nozzles and an ejection direction of the ink droplets by providing a detection member, to which a voltage is applied, in parallel with a nozzle array and detecting an induction current flowing in the detection member when the ink droplets ejected from the nozzles pass by the vicinity of the detection member. JP-A-2003-251829 discloses a method where ink is sucked when a clogged state is detected, but ink and time consumed during a suction operation is reduced by changing the operational amount of suction according to a detection frequency. JP-A-2006-130869 discloses a method of performing a flushing operation when a clogged state is detected, and performing a wiping operation when the ejection direction of the ink is abnormal. JP-A-2001-212970 discloses a configuration, where a dead pixel is detected by a laser, in which inspection of the dead pixel is performed several times by changing the irradiation angle of the laser in order to improve detection accuracy of the dead pixel.

In the case of the clogged state in which ink is not ejected from the nozzles, a method of solving the clogging by sucking the ink is effective. In a case where there is no clogged state but the ejection direction of the ink is unstable, maintenance through suction is valid. However, other maintenance methods which can reduce the amount of ink consumed and shorten the time compared with maintenance by suction are also valid. Accordingly, in the case of the unstable ejection state, it is particularly preferable to perform the maintenance by which the amount of ink consumed is small and the time required is short. In JP-A-2006-142554, even in the case of the clogged state in which ink is not ejected from the nozzles and the case where the ejection direction is abnormal even though the ink is ejected, cleaning is performed using suction and wiping in the same manner. In JP-A-2003-251829, only when the clogged state is detected, maintenance is performed. In JPA-2006-130869, although different maintenance operations are performed depending upon the ejection state of the ink, the reference used to determine the ejection state is not different for each ink.

### SUMMARY

An advantage of some aspects of the invention is that it optimizes a maintenance method of nozzles in a case of a clogged state or an unstable ejection state.

According to an aspect of the invention, there is provided a printing apparatus including a measuring unit which measures an actual measurement value indicating an ejection state of ink ejected from nozzles; a determination unit which compares the actual measurement value with a first threshold value and a second threshold value which are set for each ink color to determine whether or not the ejection state of the ink is among three states of a normal state and a clogged state, which are distinguished by the first threshold value and the second threshold value, and an unstable ejection state between the normal state and the clogged state; and a maintenance unit which performs different maintenance operations in accordance with the determination result.

The printing apparatus according to the aspect of the invention compares the actual measurement value indicating the ejection state of the ink with two threshold values to determine which is the ejection state of the ink among three states which are distinguished by two threshold values, and performs the maintenance operation previously determined as the maintenance method corresponding to the determined state. The term “corresponding maintenance operation” means a maintenance operation controlled to appropriately balance an effect obtained by the maintenance operation and a cost such as the amount of the ink consumed in the maintenance operation or the time required for the maintenance operation. According to the aspect of the invention, the ejection state of the nozzles is compiled by setting the above-described two threshold values for each color, and comparing the actual measurement value with the threshold values for each ink. For this reason, the maintenance operation corresponding to the respective states for each ink can be performed.

The term “clogged state” means a state in which ink droplets are not ejected from the nozzles, that is, a state in which there is a dead pixel. The term “unstable ejection state” means a state in which the ink droplets are ejected from the nozzles, but the travelling direction of the ink droplets is in an abnormal state. For example, it is a state in which the ink droplets do not travel vertically but in a curve relative to a printing surface, or the ink droplets from one nozzle are scattered in a plurality of directions.

In the printing apparatus, the maintenance unit may perform the maintenance operation including a suction operation of the ink in a case where it is determined that the ejection state of the ink is in the clogged state, and perform the maintenance operation which does not include the suction operation of the ink in a case where it is determined that the ejection state of the ink is in the unstable state.

The method of executing the maintenance operation includes, for example, suction, flushing, wiping and so forth. The suction operation consumes a lot of ink compared with another method. However, in order to recover the ejection performance of the ink by resolving the clogged state, the suction operation is more reliable and most appropriate compared with other methods. According to the aspect of the invention, the maintenance operation including the suction operation is performed only in the case that the clogged state is determined. Even in the flushing operation, ink is consumed, but the consumption amount is small compared to the suction operation. In the wiping operation, ink is not consumed. In the case of determining that it is in the unstable ejection state, by not performing he maintenance operation including the suction operation, increase in the amount of ink consumed, the total time required for the maintenance operation by performing the maintenance operation including the suction operation when it is not a clogged state, can be prevented.

In the printing apparatus, the maintenance unit may perform the maintenance operation including the suction operation when the number of nozzles, which are determined that it is the clogged state, is equal to or more than predetermined number.

The term “predetermined number” is a number which is a condition for performing the maintenance operation including the suction operation, and is previously set in view of the cost (the time required for the maintenance operation and the amount of ink consumed for the maintenance operation) and the effect on the image quality of the printing result. If the maintenance operation including the suction operation is performed whenever the number of nozzles of the clogged state is less than the predetermined number, there are costs, while the effect of improving the image quality which is obtained by performing the maintenance operation including the suction operation for the whole nozzle array or the entire head so as to solve the clogging of the nozzles less than the predetermined number is small and it costs a lot. According to the aspect of the invention, it is possible to control the balance between the cost and the effect of improving the image quality which can be obtained by the maintenance operation.

The printing apparatus may include a high-frequency determination unit which determines whether the ejection state of the ink is in the clogged state or not at a frequency higher than the determination unit using a threshold value which distinguishes between a normal state or an unstable ejection state and a clogged state among the first threshold value and the second threshold value, and lets the maintenance unit perform the maintenance operation including the suction operation in the case of the clogged state.

It is known that the occurrence frequency of the clogged state is higher than that of the unstable ejection state. For this reason, since the frequency of determining which is the ejection state of the ink among three states of the normal state, the clogged state, and the unstable ejection state is set to be lower than the frequency of determining whether the ejection state is in the clogged state or a state other than the clogged state, it is possible to shorten the time required for inspecting the ejection state of the ink and to reduce the amount of the ink consumed when checking the ejection state.

In the printing apparatus, at least one of the first threshold value and the second threshold value may be set as a value to relax the performing conditions of the maintenance operation if the brightness difference is small between the color of the ink and a color of the ink which is assumed to be the color of a printing medium. Since the color of the ink with a small brightness difference between the color of the ink and the color of the printing medium is difficult to distinguish by the human eye in view of the difference of ejection state compared to the color of the ink with a large brightness difference, the nozzles of the ink of color with a small brightness difference relaxes the performing conditions of the maintenance operation compared with the nozzles of the ink of color with large brightness difference. As a result, it is possible to control the balance between the cost, such as time required for the maintenance operation or ink consumed for the maintenance operation, and the effect which can be obtained by the maintenance operation.

In the printing apparatus, the maintenance unit may perform the maintenance operation based on a representative value of the multiple actual measurement values.

According to the invention, it is possible to reduce the possibility of performing the inappropriate maintenance operation for the actual ejection state due to erroneous determination in regards to the ejection state of the ink. For example, the ejection state of the ink is determined by comparing the threshold value with the representative value (a median value, a mode value, a mean value or the like) of multiple actual measurement values. By doing so, the inappropriate maintenance operation can be reduced.

In the printing apparatus, the measurement unit may measure an amount of variation in potential, which is associated with capacitance variation between a plate electrode of the nozzles opposite to the ejection direction of the ink with respect to the arranged surface and a plate electrode installed at the arranged surface of the nozzles, as the actual measurement value indicating the ejection state of the ink.

The capacitance between the plate electrode installed at the arranged surface of the nozzles and the opposite plate electrode thereof varies in the state where the ink droplets are not ejected from the nozzles and the state where the ink droplets are just about to separate from the nozzles when the ink droplets can be ejected from the nozzle. As the capacitance is varied, the current flows, so that the potential of the plate electrode is changed. According to the aspect of the invention, the measured amount of the variation in potential can be used as a means to determine the ejection state of the ink.

In the printing apparatus, different operation may be performed for each ink in the maintenance operation.

According to the invention, in the case where the nozzle in a state requiring the maintenance operation is a nozzle corresponding to a specific ink, since the maintenance operation can be performed not on the nozzles corresponding to all inks but only on the nozzle array in a state requiring the maintenance operation, it is possible to reduce the amount of ink consumed in the maintenance operation. That is, it is possible to precisely control the cost and the effect of improving the image quality by the maintenance operation.

The functions of the respective units described in claims are implemented by hardware resources for which the functions are specified in the configuration itself, hardware resources for which the functions are specified by a program, or a combination thereof. In addition, the functions of the respective units are not limited to functions to be implemented by hardware resources which are physically independent with each other. Furthermore, the invention is accomplished as a method of performing the above-described contents, a control program of controlling the printing apparatus having the above-described functions, or a recording medium recording the control program. Of course, the recording medium of the control program may include a magnetic recording medium, a magneto-optical recording medium, and any recording mediums which will be developed in future.

### BRIEF DESCRIPTION OF THE DRAWINGS

The invention will be described with reference to the accompanying drawings, wherein like numbers reference like elements.

FIG. 1 is a block diagram illustrating a printing system according to an embodiment of the invention.

FIG. 2 is a schematic diagram illustrating a moving range of a carriage according to an embodiment of the invention.

FIG. 3 is a schematic diagram illustrating a nozzle surface according to an embodiment of the invention.

FIG. 4 is a schematic diagram illustrating a head and a cap according to an embodiment of the invention.

FIG. 5 is a schematic diagram illustrating a cap according to an embodiment of the invention.

FIG. 6 is a view illustrating inspection of an ejection state according to an embodiment of the invention.

FIGS. 7A to 7C are views illustrating a signal used in detection of an ejection state according to an embodiment of the invention.

FIGS. 8A and 8B are views illustrating two threshold values according to an embodiment of the invention.

FIG. 9 is a flow chart illustrating a maintenance process A according to an embodiment of the invention.

FIG. 10 is a flow chart illustrating an inspection process of an ejection state according to an embodiment of the invention.

FIG. 11 is a flow chart illustrating a maintenance process B according to an embodiment of the invention.

### DESCRIPTION OF EXEMPLARY EMBODIMENTS

Embodiments of the invention will now be described in the following order with reference to the accompanying drawings. In this instance, the corresponding constituent elements are designated by like reference numerals throughout several of the drawings, and overlapping descriptions thereof will be omitted.

### 1. First Embodiment

### 1-1. Configuration

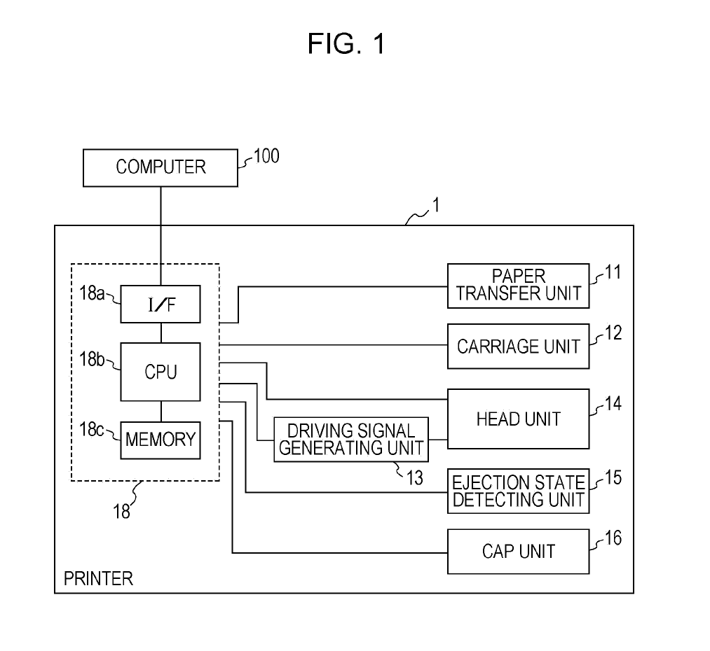

FIG. 1 is a block diagram illustrating a printing system including an ink jet printer 1 (hereinafter referred to as a printer) serving as a printing apparatus, and a personal computer PC 100. The printer 1 ejects ink towards a printing medium, such as paper, fabric, film or the like, to form (print) an image on the printing medium. The PC 100 is communicably connected to the printer 1. In order for the printer 1 to print the image, the PC 100 transmits print data corresponding to the image to the printer 1.

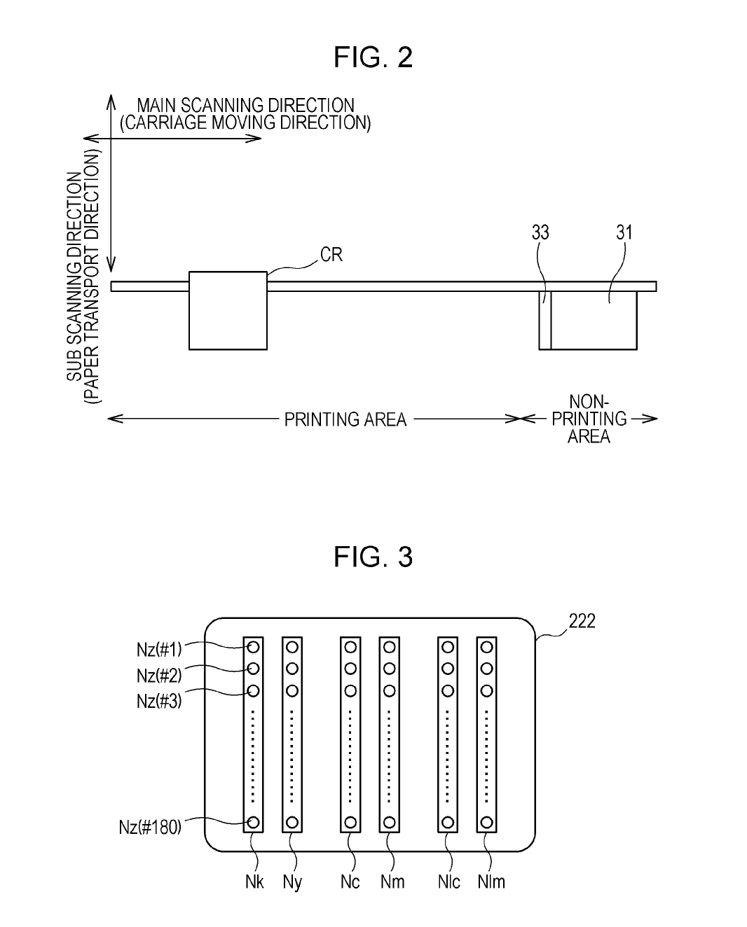

The printer 1 includes a paper transfer unit 11, a carriage unit 12, a driving signal generating circuit 13, a head unit 14, an ejection state detecting unit 15, a cap unit 16, and a controller 18. The paper transport unit 11 has a paper transfer roller (not illustrated), a paper transfer motor (not illustrated) and so forth, and transports the paper in a sub scanning direction (a paper transport direction), as shown in FIG. 2. The carriage unit 12 has a carriage CR attached to the head unit 14, a carriage motor (not illustrated) and so forth, and moves the carriage CR in a main scanning direction (a direction perpendicular to the paper transport direction), as shown in FIG. 2. The carriage CR is provided with a cartridge mounting unit for detachably mounting ink cartridges which are not illustrated. The ink cartridge is a box-shaped member filled with liquid type ink, and stores with ink of different color.

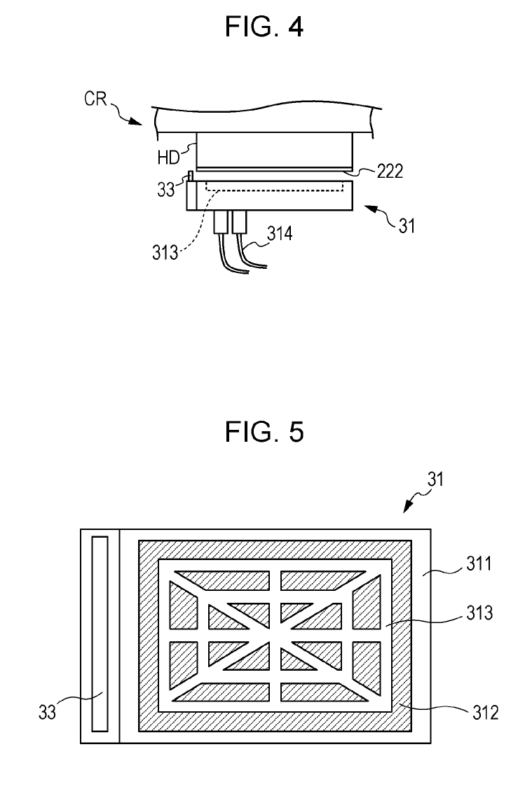

The head unit 14 has a head HD and so forth. The head HD is driven by a driving signal output from the driving signal generating circuit 13, and ejects the ink supplied from the ink cartridge towards the printing medium. The surface (a nozzle plate 222 in FIG. 3 and FIG. 4) of the head HD opposite to the paper is provided with a plurality of nozzles Nz for ejecting ink droplets. The nozzle plate 222 is made of a plate-shaped member (e.g., thin metal plate) with conductivity, and is connected to a ground wire so that it is adjusted to a ground potential. Thus, the nozzle plate serves as a plate electrode.

The nozzle group illustrated in FIG. 3 has plural nozzle arrays of which the nozzles Nz are arranged at a pitch of 1/180 inches. The respective nozzle arrays can determine the kind of ink to be respectively ejected. The head HD is provided with 6 nozzle arrays. More specifically, in an order from the left side in FIG. 3, a black ink nozzle array Nk, a yellow ink nozzle array Ny, a cyan ink nozzle array Nc, a magenta ink nozzle array Nm, a light cyan ink nozzle array, Nlc, and a light magenta ink nozzle array Nlm are disposed. The respective nozzle arrays eject ink of the same color as the name designated to the nozzle array. The respective nozzle array is constituted by the same number of nozzles Nz. In the head HD, one nozzle array is constituted of 180 nozzles Nz.

The driving signal generating circuit 13 generate a driving signal for driving the head HD. The driving signal is applied to the head HD when printing onto the paper. In addition, the driving signal is applied to the head HD at the time of inspecting the ejection state of the ink, or at the time of performing a flushing operation to recover the ejection ability of the nozzles or micro-vibration operation which will be described later. The head unit 14 and the driving signal generating circuit 13 correspond to the maintenance unit.

The cap unit 16 has a role of performing suction operation so as to suck ink from the respective nozzles Nz in order to suppress evaporation of the ink solvent from the nozzles Nz or recover the ejection ability of the nozzles Nz. The cap unit 16 corresponds to the maintenance unit. The cap unit 16 includes a cap 31 (refer to FIG. 2 and FIG. 4) forming a space at which the nozzle group is present, a wiper 33, and a mechanism (not illustrated) which supports the cap 31 and changes a position of the cap 31 with respect to the nozzle plate 222 of the head HD in accordance with the state of the printer 1. The cap 31 is always disposed at a non-printing area, as shown in FIG. 2, and can perform capping when the carriage CR is moved to the non-printing area. The cap 31 has a rectangular bottom portion and a sidewall portion vertically standing up from an edge of the bottom portion, and is formed in the shape of a relatively thin box, with an upper surface opposite to the nozzle plate 222 being opened. At the time of capping, the nozzle group is present in the space enclosed with the bottom portion and the sidewall portion.

At the bottom portion, a moisturizing member 312 of a sheet shape which is made of a porous material, such as felt or sponge, is disposed (refer to FIG. 5). At the time of a flushing operation, the ink is landed onto the moisturizing member 312. In addition, at the time of capping, the evaporation of the ink solvent from the nozzles Nz can be suppressed by the moisturizing member 312. The surface of the moisturizing member 312 is provided with a detection electrode 313. The detection electrode 313 is used for the inspection for the ejection state of the ink which will be described later, and is set to a high potential of about 500 V to about 600 V at the time of inspection. The illustrated detection electrode 313 has a rectangular double-frame portion, a diagonal portion connecting diagonals of the rectangular frame portion, and a cross portion connecting center points of each side of the rectangular frame portion. Due to this configuration, the detection electrode is evenly charged over the wide range due to the structure. In addition, the ink is a liquid with conductivity, and if the detection electrode 313 is applied with the high potential in a state where the moisturizing member 312 is wet, the surface of the moisturizing member 312 is set to the same potential. For this reason, the detection electrode 313 and the moisturizing member 312 serve as the plate electrode.

The space of the cap 31 is connected to a waste liquid tube 314 (refer to FIG. 4). In addition, the waste liquid tube 314 is connected to a suction pump (not illustrated). The operation of the suction pump is controlled by the controller 18. If the suction pump is operated in a state where an opened edge of the upper portion of the cap 31 comes into close contact with the nozzle plate 222, the ink or air within the head HD can be sucked from the cap 31 side via the nozzles Nz. The wiper 33 performs the wiping operation to wipe the nozzle surface (the nozzle plate 222) of the head HD, and is installed on a side of the cap 31. The wiper 33 is driven by control of the controller 18.

As described above, the cap 31 changes its position in the non-printing area in accordance with the operation or state of the printer 1. For example, at the time of a common printing operation, the cap 31 is in the state which it is retreated to a position away from the nozzle surface compared with a position in which it comes into close contact with the nozzle surface or a position in which it is spaced slightly apart from and facing the nozzle surface. When a power source is off or has been paused for a long time, the upper end of the cap 31 comes into close contact with the nozzle surface to suppress evaporation of the ink solvent from the nozzles Nz. In a case where the ink is sucked from the respective nozzles Nz to recover the ejection ability of the nozzles Nz, the upper end of the cap 31 comes into close contact with the nozzle surface to increase the air-tightness of the space. In addition, when the flushing operation to continuously eject the ink droplets from the respective nozzles Nz is performed to recover the ejection ability of the nozzle Nz or inspection of the ejection state described later is performed, the cap 31 is spaced slightly apart from the nozzle surface. FIG. 4 shows the position of the cap 31 at the time of flushing operation or the inspection of the ejection state.

In this instance, the maintenance method for recovering the ejection ability of the nozzles Nz includes a micro-vibration operation, as well as the above-described suction operation and flushing operation. The micro-vibration operation is an operation of moving a free surface of the ink, which is exposed in the nozzles Nz, to an ejection side and an inlet side by causing pressure variation to an extent that the ink droplets are not ejected, and dispersing thickened ink adjacent to the nozzles by agitation. In the suction operation, the flushing operation and the micro-vibration operation, the degree of the recovering the ejection ability of the nozzles Nz is the highest in the suction operation, and is the lowest in the micro-vibration operation. In addition, the amount of ink consumed during each operation is the highest during the suction operation, but is the lowest during the micro-vibration operation. Since each of the maintenance operation has such a characteristic difference, the printer 1 selects and uses each of the maintenance operations in accordance with the state difference.

In this embodiment, the suction operation is performed not in a unit of nozzle or a unit of nozzle array, but for all of the nozzles of the nozzle plate 222. The flushing operation or the micro-vibration operation can be performed in a unit of nozzle or a unit of nozzle array, or for the nozzles of all of the nozzle arrays. The wiping operation is performed for the whole nozzle plate 222.

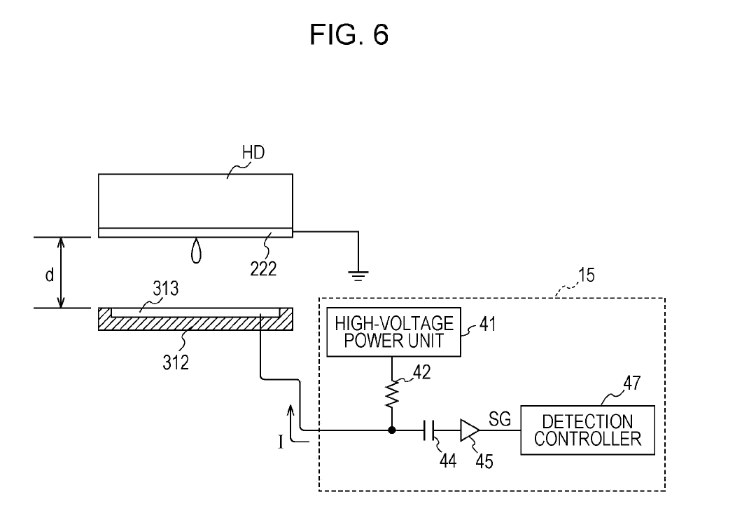

The ejection state detecting unit 15 detects the ejection state of the ink from the respective nozzles Nz. The ejection state detecting unit 15 corresponds to the measuring unit. The ejection state detecting unit 15 inspects the state of the ejection of the ink from the respective nozzles Nz constituting the nozzle group to specify the nozzle Nz in which the ejection state of the ink is not normal. As shown in FIG. 6, the ejection state detecting unit 15 includes a high-voltage power unit 41, a resistor 42, a capacitor 44, an amplifier 45, and a detection controller 47.

The high-voltage power unit 41 is a power source applying the detection electrode 313 with a predetermined potential. The high-voltage power unit 41 according to this embodiment is constituted by a DC power source of about 500 V to about 600 V, and its operation is controlled by a control signal from the detection controller 47. One end portion of the resistor 42 is connected to an output terminal of the high-voltage power unit 41, and the other end portion is connected to the detection electrode 313. The capacitor 44 is a device for extracting a component for varying the potential of the detection electrode 313, of which one conductor is connected to the detection electrode 313, and the other conductor is connected to the amplifier 45. The amplifier 45 amplifies the signal (variation in potential) indicated at the other end portion of the capacitor 44 so as to output it.

The detection controller 47 is an element for controlling the ejection state detecting unit 15. The detection controller 47 has a resistor group, an AD converter, a voltage comparator, and a control signal output portion. The resistor group is constituted of a plurality of resistors, and each of the resistors is stored with a determination result for every nozzle Nz and a voltage threshold value for determination. The AD converter converts the amplified voltage signal (an analog value) output from the amplifier 45 to a digital value. The voltage comparator compares the voltage threshold value with the magnitude of the amplitude value based on the amplified voltage signal. The control signal output portion outputs the control signal for controlling the operation of the high-voltage power unit 41. In this instance, the inspection of the ejection state performed by the ejection state detecting unit 15 will be described later.

The controller 18 performs the overall control of the printer 1. If the controller 18 obtains printing data from the PC 100, the controller controls objects to be controlled, and prints the image on the paper. In addition, the controller 18 is associated with the execution of the printing operation of the printer 1, or performs the inspection of the ejection state described later accompanying with the initial operation when the power source is turned on.

As shown in FIG. 1, the controller 18 includes an interface portion 18a, a CPU 18b, and a memory 18c. The interface portion 18a performs data exchange with the PC 100. The CPU 18b is connected to the respective units of the printer 1 via interfaces (not illustrated) to perform the overall control. The memory 18c secures a region for storing a control program, a working region, and so forth. The CPU 18b controls each object to be controlled in accordance with the control program stored in the memory 18c. For example, the CPU 18b controls the paper transport unit 11, the carriage unit 12, the suction pump of the cap unit 16 or the like. In addition, the CPU transmits the control signal for generating a driving signal to the driving signal generating circuit 13. Furthermore, the CPU communicates with the detection controller 47 of the ejection state detecting unit 15 to transmit or receive necessary information.

The controller 18 serves as the high-frequency determination unit when the maintenance process A described later is executed, while serving as the determination unit when the maintenance process B is executed.

### 1-2. Regarding the Inspection of Ejection State

As described above, in the printer 1, the nozzle plate 222 is connected to the ground to be set at a ground potential, and the detection electrode 313 disposed at the cap 31 is set at a high potential of about 500 V to about 600 V. The nozzle plate 222 and the detection electrode 313 are disposed in a state where they are spaced apart from each other at a predetermined interval d (refer to FIG. 6), and the ink droplets are ejected from the nozzles Nz which are targeted for detection. The capacitor is formed by spacing the nozzle plate 222 and the detection electrode 313 at the predetermined interval d. As shown in FIG. 6, the ink extending from the nozzle Nz in a column shape comes into contact with the nozzle plate 222 which is connected to the ground, so that the ink is set at the ground potential. The presence of the ink means that the electrode interval of the capacitor is locally decreased, and thus the capacitance is increased. If the capacitance is increased, the amount of charge which can be accumulated between the nozzle plate 222 and the detection electrode 313 is increased. As described above, if the capacitance is increased or if capacitance which had decreased is recovered, the charges move from the high-voltage power unit 41 to the detection electrode 313 side via the resistor 42. That is, an electric current I flows toward the detection electrode 313. If the electric current I flows, the potential of the detection electrode 313 is varied. The variation in the potential of the detection electrode 313 is shown as the variation in the potential of the other conductor (the conductor of the amplifier 45 side) in the capacitor 44. Accordingly, it is possible to determine the ejection state of the ink droplets by inspecting the variation in the potential of the other conductor.

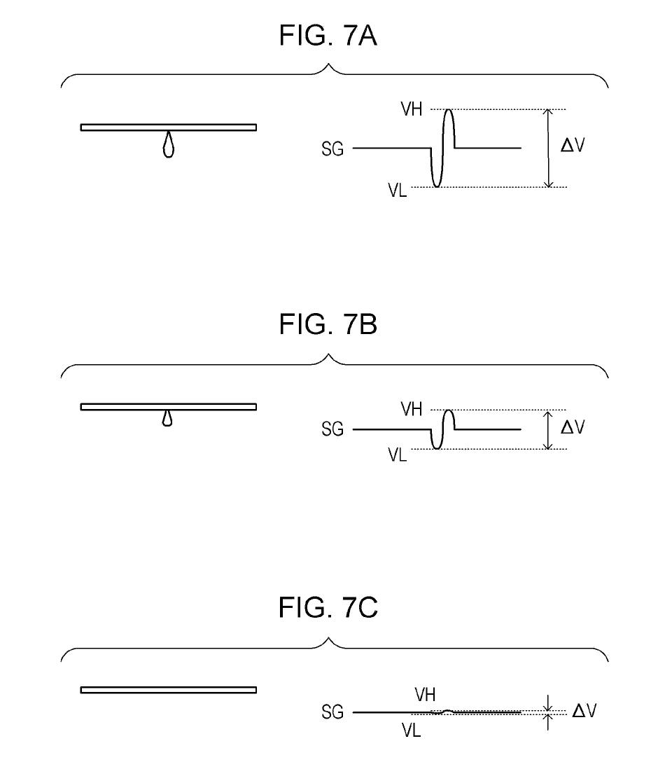

FIG. 7A is a view illustrating a voltage signal SG output from the amplifier 45 when the ink is normally ejected from the nozzles Nz. If the driving signal generating signal 13 generates the driving signal to eject the ink from one nozzle Nz which is targeted for inspection, the ink droplet is ejected from the nozzle Nz. Accordingly, the voltage signal SG is output from the amplifier 45. The detection controller 47 compares a potential difference AV between the highest voltage VH and the lowest voltage VL of the voltage signal SG to the first threshold value TH1 and the second threshold value TH2 in magnitude to determine the ejection state of the ink. The voltage difference AV corresponds to an actual measurement value set forth in the claims.

In this embodiment, the ejection state of the ink is classified into the following three states: a normal state; an unstable ejection state in which the ink droplets are ejected from the nozzles but the ejection direction of the ink droplets is not normal; and a clogged state in which the nozzles are clogged and thus the ink droplets are not ejected. FIG. 7B is a view illustrating the voltage signal SG output from the amplifier 45 when the ink droplets are ejected from the nozzles of the unstable ejection state. In the case of the unstable ejection state in which the ink does not land vertically with respect to the plane of the printing medium, it is known that the length (the distance from a portion closest to the cap 31 side of the ink droplet to the nozzle plate 222) of the ink droplet, immediately before the ink droplet is ejected from the nozzle, becomes shorter than that in the case of the normal state. For this reason, the potential difference ΔV is small compared with the normal state. In the case of the nozzle of the unstable ejection state, the landed portion of the ink by the nozzle is seen lighter color than the landed portion of the nozzle of the normal state. FIG. 7C is a view illustrating the voltage signal SG when the ink droplets are about to be ejected from the nozzles in the clogged state. In the state where the nozzles are clogged and thus almost no ink droplets are ejected, which is called a dead pixel, as shown in FIG. 7C, the potential difference ΔV is a small value compared with the case of the unstable ejection state.

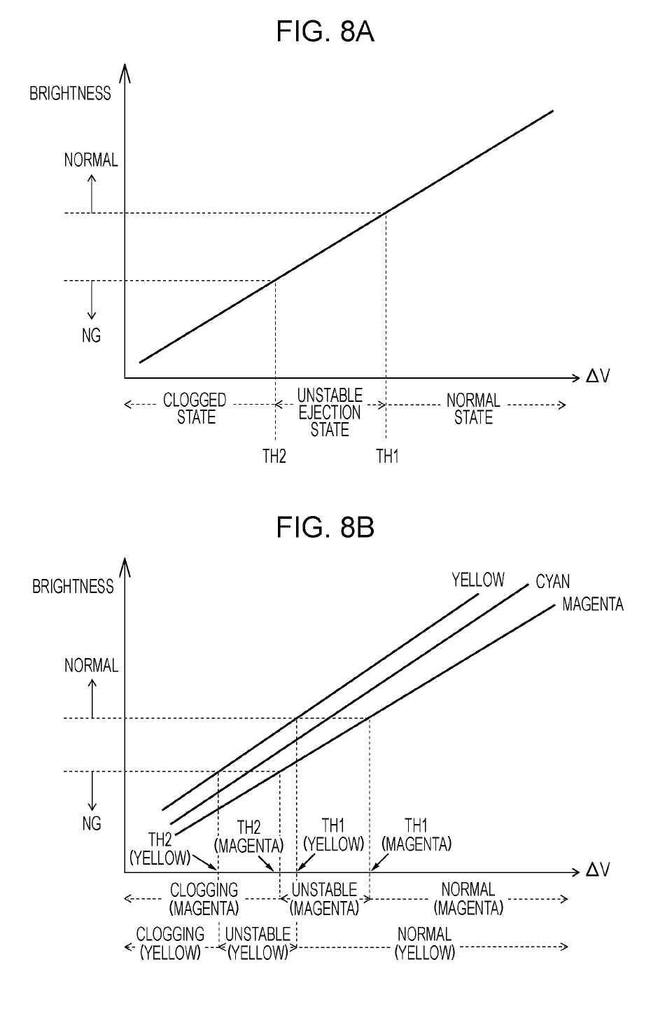

Accordingly, in order to distinguish the three states, two threshold values of a first threshold value TH1 and a second threshold value TH2 are used. If the potential difference ΔV is equal to or more than the first threshold value TH1 (refer to FIG. 8A), it is determined to be in the normal state in which the ink is normally ejected. If the potential difference ΔV is less than the second threshold value TH2, it is determined to be in the clogged state in which the ink is not ejected. If the potential difference ΔV is less than the first threshold value TH1 and equal to or more than the second threshold value TH2, it is determined to be the unstable ejection state. In this instance, the first threshold value TH1 and the second threshold value TH2 are set in accordance with the brightness difference between the ink and color which is assumed to be the color of the printing medium. More specifically, the threshold value of the ink having the color with a small brightness difference is set to be smaller than that of the ink having the color with large brightness difference. For example, since the color of the printing medium is assumed to have a brightness that is higher than the 6 ink colors in the printer 1 according to the embodiment, the first threshold value TH1 of yellow, of which the brightness difference between the yellow color and the color of the printing medium is smaller than magenta, is set to be smaller than the first threshold value TH1 of magenta, and the second threshold value TH2 of yellow is set to be smaller than the second threshold value TH2 of the magenta. Since the color with a small brightness difference between the color and the color of the printing medium itself is hard to distinguish by human eye in view of the difference of ejection state compared to a color with a large brightness difference, it means that the nozzles of the ink with small brightness differences relax the execution conditions of the maintenance operation compared with the nozzles of the ink of a color with large brightness difference, as shown in FIG. 8B. As a result, it is possible to control the balance between the cost, such as time required for the maintenance operation or ink consumed for the maintenance operation, and the effect which can be obtained by the maintenance operation.

As described in FIG. 3, the head HD used in the printer 1 is provided with 6 nozzle arrays Nk to Nlm. Each of the nozzle arrays Nk to Nlm is constituted of 180 nozzles Nz. For this reason, 1080 (180×6 rows) nozzles Nz are targeted for inspection for inspection of ejection state of one time. In this instance, 15 nozzles Nz constitute one block in the printer 1 (one nozzle array is divided into 12 blocks), and the inspection of the ejection state is performed in a block unit.

### 1-3. Maintenance Process

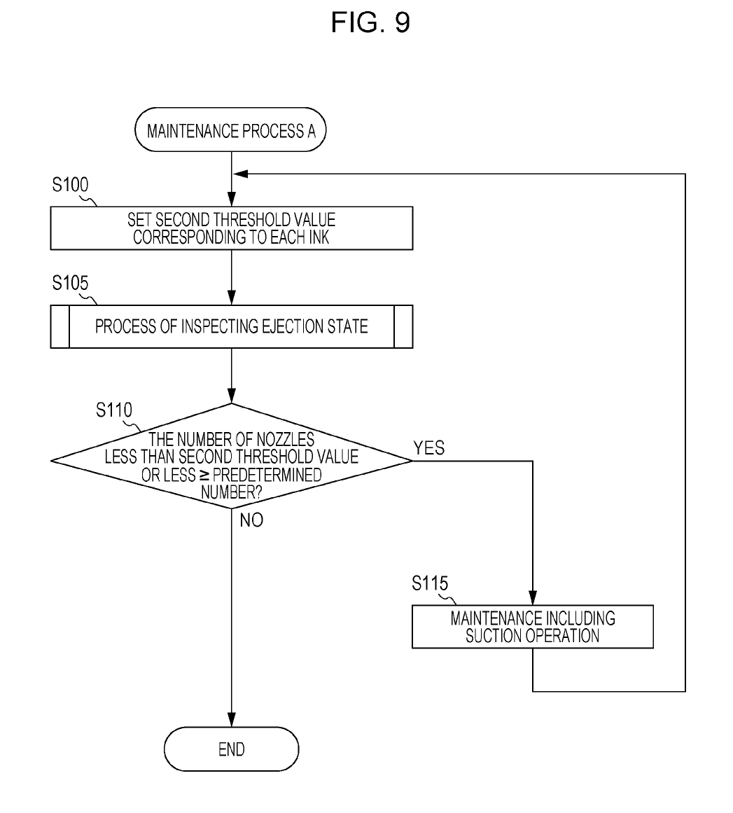

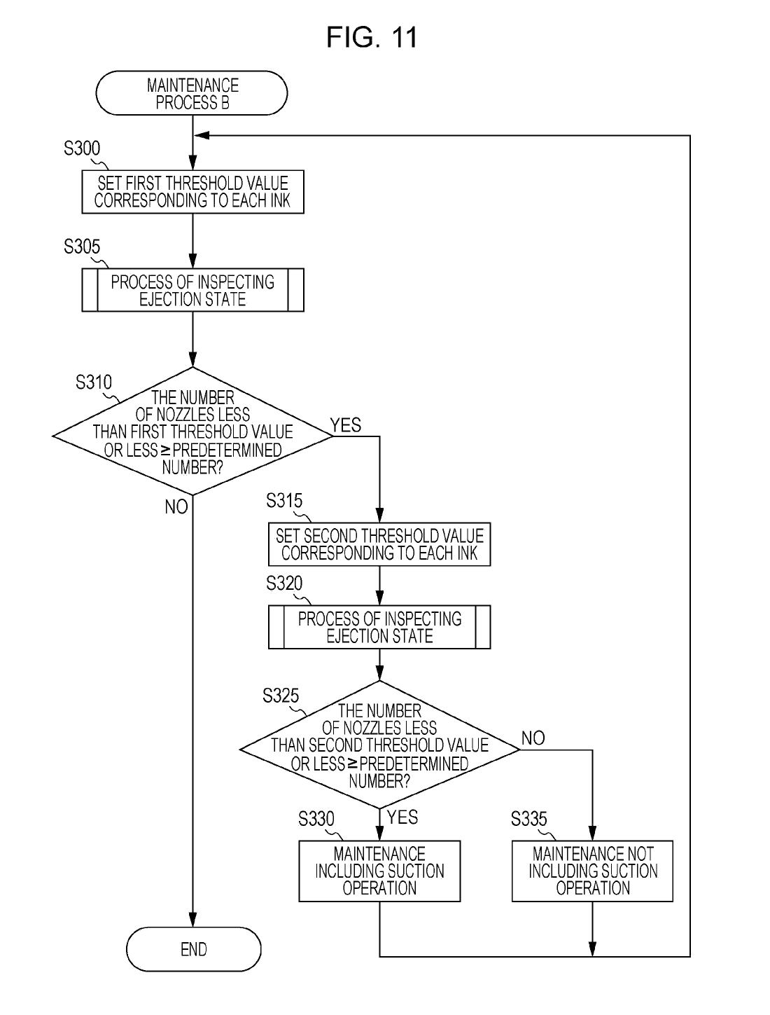

Next, the operation of the printer 1 including the above-described configuration will be described. When the controller 18 of the printer 1 receives the print instruction from the PC 100 to execute the print, the maintenance process A shown in FIG. 9 is executed prior to the printing operation corresponding to printing job for every printing job. In addition, the maintenance process B shown in FIG. 11 is changed to the maintenance process A at a ratio of one to multiple printing operations (e.g., one to every 10 printing jobs), and then is executed. In the maintenance process A, it is determined whether it is in the clogged state or other states, and if it is in the clogged state, the corresponding maintenance is executed. In the maintenance process B, it is determined whether it is in the clogged state, the unstable ejection state or the normal state, and if it is in either of the two states other than the normal state, the maintenance operation corresponding to each state is executed. In this instance, either the maintenance process A or the maintenance process B may be executed in a case where the independent execution of the maintenance operation regardless of the printing operation is instructed from the PC 100. First, the maintenance process A will be described.

### 1-3-1. Maintenance Process A

The maintenance process A will be described with reference to FIG. 9. First, the controller 18 sets the second threshold value TH2 as a threshold value which is used as a comparison object in the process of inspecting the ejection state corresponding to each ink (step S100), and executes the process of inspecting the ejection state (step S105). Herein, the second threshold value TH2 is set for each ink color. Since ink of 6 colors is used in this embodiment, 6 values are set as the second threshold value TH2. The second threshold value TH2 is set in such a way that a second threshold value corresponding to the ink with a small brightness difference between the ink and the printing medium is smaller than a second threshold value corresponding to the ink with a large brightness difference between the ink and the printing medium. The detailed flow of the process of inspecting the ejection state will be described later, but the contents of the operation are identical to those described above.

The controller 18 determines whether or not the number of the nozzles, of which the potential difference ΔV is less than the second threshold value TH2 as the result obtained by the process of inspecting the ejection state, is equal to or more than a predetermined number (step S110). That is, as a result of inspecting all the nozzles of 6 nozzle arrays, it is determined whether or not the predetermined number or more of the nozzles in the clogged state exist. The term “predetermined number” means a value under the condition of performing the maintenance operation including the suction operation, and is previously set in view of the cost (the time required for the maintenance operation and the amount of the ink consumed for the maintenance operation) and the effect on the image quality of the printing result. If the maintenance operation including the suction operation is performed even if the number of nozzles of the clogged state is less than the predetermined number, there are costs, while the effect of improving the image quality before and after the maintenance operation which is obtained by performing the maintenance operation including the suction operation for the whole nozzle head (the overall nozzle) to solve the clogging of the nozzles less than the predetermined number, is small, but the cost is high. Accordingly, in this embodiment, if it is determined in step S110 that the number of the nozzles, of which the potential difference ΔV is less than the second threshold value TH2, is not equal to or more than the predetermined number, the maintenance operation is not performed, and the maintenance process A is ended. If it is determined that the number of the nozzles is equal to or more than the predetermined number, the controller 18 executes the maintenance operation including the suction operation (step S115), and terminates the maintenance process A. The maintenance operation including the suction operation is maintenance operation including at least suction operation described above, and the suction operation, the flushing operation and the wiping operation are executed in this embodiment.

### 1-3-2. Process of Inspecting Ejection State

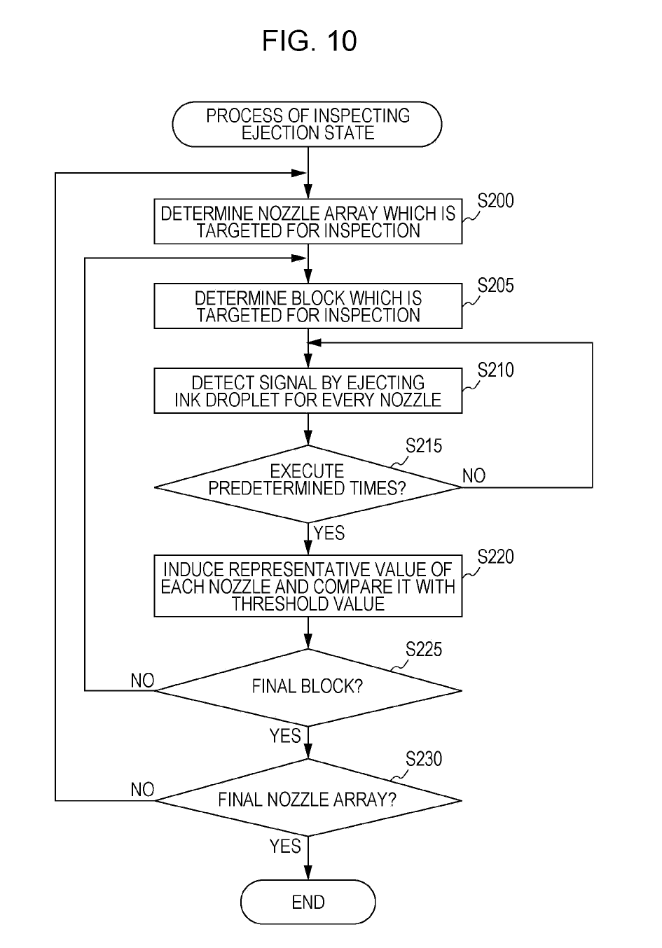

Next, the detailed sequence of the process of inspecting the ejection state in step S115 of FIG. 9 will be described with reference to FIG. 10. The inspection of the ejection state is performed in the state in which the carriage CR is moved to the inspection position (the non-printing area shown in FIG. 2). In the process of inspecting the ejection state, the detection controller 47 determines the nozzle array which is preferably targeted for inspection (step S200). As described in FIG. 3, the head HD is provided with 6 nozzle arrays. One of the 6 nozzle arrays is decided upon as a nozzle array which is targeted for inspection.

If the nozzle array which is targeted for inspection is decided upon, the detection controller 47 determines the block which is targeted for inspection (step S205). As described above, one block is constituted of 15 nozzles Nz. Accordingly, one nozzle array includes 12 blocks. Herein, among 12 blocks, one block which is targeted for inspection is decided. For example, the first block constituted of first to fifteenth nozzles Nz is selected.

If the block which is targeted for inspection is decided upon, the detection controller 47 performs the ejection of the ink droplets and the detection of the voltage signal SG with respect to the block (step S210). More specifically, the detection controller ejects the ink droplet from each nozzle with respect to the nozzles Nz belonging to the target block, and obtains the electrical change which resulted from the ejection of the ink droplet, that is, the difference in potential ΔV corresponding to each nozzle Nz.

If the step S210 is ended with respect to all nozzles belonging to one block, the detection controller 47 determines whether or not the ejection of the ink droplet and the detection of the signal are executed for the predetermined number of times per one nozzle (step S215). If it is less than the predetermined number of times, the step S210 is repeated until the predetermined number of times is reached. The multiple times of ΔV detection results are not overwritten and deleted, but are respectively maintained for multiple times. After the detection is performed a predetermined number of times, the detection controller 47 derives a representative value (a median value, a mode value, a mean value or the like) of the multiple times of differences in potential ΔV for every nozzle, and compares the representative value with the threshold value (the threshold value for each ink set in the process requesting the process of inspecting the ejection state) (step S220). More specifically, the comparison of the threshold value for the ink corresponding to the nozzle array, to which the nozzles Nz which are targeted for comparison belong, to the representative value of the difference in potential ΔV of the nozzles which are targeted for comparison is performed by the voltage comparator. For example, if the process of inspecting the ejection state is requested in the state where the first threshold value TH1 is set as the threshold value used for the comparison, and the nozzle which is targeted for inspection corresponds to yellow, the first threshold value TH1 of yellow and the representative value of ΔV for the nozzle which is targeted for inspection is compared. The comparison result is stored in the register of the detection controller 47. For example, a value indicating “threshold value or more” or “less than threshold value” as the comparison result is stored. It is possible to reduce the possibility of performing an inappropriate maintenance operation due to erroneous determination of the ejection state of the ink, by using the representative value of the multiple inspection results for one nozzle in the comparison.

Then, the detection controller 47 determines whether or not the block which is targeted for inspection is a final block in the nozzle array which is targeted for inspection (step S225). If it is not the final block, it returns to the step S205 to perform the above-described process for the next block. If it is the final block, the detection controller 47 determines whether or not the nozzle array which is targeted for inspection is the final nozzle array among multiple nozzle arrays (step S230). If it is not the final nozzle array, the controller 18 returns to the step S200, and performs the above-described process for the next nozzle array. If it is the final nozzle array, the process of inspecting the ejection state is ended while the determination result until now is maintained, and it returns to the process of a source of the request.

### 1-3-3. Maintenance Process B

The maintenance process B will be described with reference to FIG. 11. First, the controller 18 sets the first threshold value TH1 corresponding to each ink (step S300), and executes the process of inspecting the ejection state (step S305). More specifically, 6 values are set as the first threshold values TH1 of 6 ink colors, and the process of inspecting the ejection state shown in FIG. 10 is requested. The first threshold value TH1 is set in such a way that a first threshold value corresponding to the ink with a small brightness difference between the ink and the printing medium is smaller than a first threshold value corresponding to the ink with large brightness difference between the ink and the printing medium. After the process of inspecting the ejection state is performed, the controller 18 determines whether or not the number of the nozzles less than the first threshold value TH1 is equal to or more than the predetermine number (step S310). If the number of the nozzles less than the first threshold value TH1 is equal to or more than the predetermined number, that is, if the number of the nozzles which are not in the normal state (the unstable ejection state or the clogged state) is equal to or more than the predetermined number, the controller 18 sets the second threshold value TH2 corresponding to each ink (step S315), and executes the process of inspecting the ejection state (step S320). More specifically, similar to the maintenance process A, 6 values are set as the second threshold value TH2 of 6 ink colors, and the process of inspecting the ejection state shown in FIG. 10 is requested.

After the process of inspecting the ejection state is executed, the controller 18 determines whether or not the number of the nozzles less than the second threshold value TH2 is equal to or more than the predetermine number (step S325). If the number of the nozzles less than the second threshold value TH2 is equal to or more than the predetermined number, that is, in the case where the number of nozzles of the clogged state is equal to or more than the predetermined number, the controller 18 executes the maintenance operation including the suction operation. More specifically, the maintenance operation including the suction operation, the flushing operation and the wiping operation is executed (step S330). If the number of the nozzles less than the second threshold value TH2 is not equal to or more than the predetermined number, the controller 18 executes the maintenance operation which does not include the suction operation (step S335). As the maintenance operation which does not include the suction operation, for example, the controller 18 executes the flushing operation and the wiping operation. The micro-vibration operation can be performed. If it is determined to be the unstable ejection state, since the maintenance operation including the suction operation is not executed, it is possible to prevent an increase in the amount of the ink consumed or an increase in the total time required for the maintenance operation by executing the maintenance operation including the suction operation even in the case where it is not the clogged state.

### 1-4. Summary

In this embodiment, the maintenance process B is executed at frequency lower than the maintenance process A. The reason is that it is known that the occurrence frequency of the clogged state is higher than that of the unstable ejection state. As described above, the number of times of inspection of the maintenance process A, where it is inspected as to whether or not there is the clogged state, is fewer than in the maintenance process B, where it is determined what the ejection state of the ink is from among three states of the normal state, the clogged state, and the unstable ejection state. Therefore, the processing time is shorter, and the amount of the ink consumed for the inspections is smaller. Accordingly, by performing the maintenance process A at higher frequency than the maintenance process B, it is possible to prevent an increase each time in the time required to inspect the ejection state of the ink, and to reduce the amount of the ink consumed for inspection of the ejection state. In addition, by executing the maintenance process B although it is at a lower frequency than the maintenance process A, it is possible to detect the unstable ejection state which is not the clogged state or the normal state. In order to recover the ejection ability of the nozzles of the unstable ejection state, it is possible to perform the maintenance operation with an optimum balance of the effect and the cost.

2. Other embodiments

The technical scope of the invention is not limited to the embodiment described herein. It is to be understood that the invention may be variously modified without departing from the spirit or scope of the invention. For example, although the embodiment, in which the first threshold value TH1 and the second threshold value TH2 are set as different values for each ink color, has been described, any of them, for example, only the first threshold value TH1 may be set as different values for each ink, and the second threshold value TH2 may be set as a common value all of the inks. That is, the second threshold value TH2 for determining the clogged state is set as the common value for the whole ink, and only the first threshold value TH1 for defining the boundary of the unstable ejection state and the normal state may be set for each ink color.

In addition, although the configuration in which the suction operation is performed for all of the nozzles has been described in the embodiment, for example, if it is configured to perform the suction operation for every nozzle array (ink), the maintenance method may be set for every nozzle array. By doing so, it is possible to precisely control the effect of improving the image quality and the cost due to the maintenance operation. More specifically, for example, in the case of the nozzle array in which the predetermined number or more of the nozzles of the clogged state exist, the suction operation is performed, the flushing operation is performed with respect to the nozzles of the clogged state, and finally the wiping operation is performed. In the case of the nozzle array in which the predetermined number of more of the nozzles of the unstable ejection state exist and less than the predetermined time the nozzles of the clogged state exist, the flushing operation is performed with respect to the nozzles of the unstable ejection state, and finally the wiping operation is performed. In the case of the nozzle array in which the nozzles of the unstable ejection state are equal to or more than the predetermined number and there is no nozzle of the clogged state, the micro-vibration operation is performed with respect to the nozzles of the unstable ejection state, and finally the wiping operation is performed.

The entire disclosure of Japanese Patent Application No. 2010-015128, filed Jan. 27, 2010 is expressly incorporated by reference herein.

What is claimed is:

1. A printing apparatus comprising:
a measuring unit which measures an actual measurement value indicating an ejection state of ink ejected from nozzles;
a determination unit which compares the actual measurement value with a first threshold value and a second threshold value which are set for each ink color to determine which is the ejection state of the ink among three states of a normal state, a clogged state, and an unstable ejection state between the normal state and the clogged state, which are distinguished out of the first threshold value and the second threshold value; and
a maintenance unit which performs different maintenance operation in accordance with a determination result.

2. The printing apparatus according to claim 1, wherein the maintenance unit performs the maintenance operation including suction operation of the ink in a case where it is determined that the ejection state of the ink is in the clogged state, and performs the maintenance operation which does not include the suction operation of the ink in a case where it is determined that the ejection state of the ink is in the unstable state.

3. The printing apparatus according to claim 2, wherein the maintenance unit performs the maintenance operation including the suction operation when the number of nozzles, which are determined to be in the clogged state, is equal to or more than a predetermined number.

4. The printing apparatus according to claim 2, further comprising a high-frequency determination unit which determines whether the ejection state of the ink is in the clogged state or not at a frequency higher than the determination unit using a threshold value which distinguishes a clogged state from between a normal state and a unstable ejection state out of the first threshold value and the second threshold value, and lets the maintenance unit perform the maintenance operation including the suction operation in the case of the clogged state.

5. The printing apparatus according to claim 2, wherein at least one of the first threshold value and the second threshold value is set as a value to relax performing conditions of the maintenance operation if the brightness difference is small between the color of the ink and color which is assumed to be a color of a printing medium.

6. The printing apparatus according to claim 1, wherein the maintenance unit performs the maintenance operation based on a representative value of the multiple actual measurement values.

7. The printing apparatus according to claim 1, wherein the measurement unit measures an amount of variation in potential, which is associated with capacitance variation between a plate electrodes opposite to the ejection direction of the ink with respect to an arranged surface of the nozzles and a plate electrode installed at the arranged surface of the nozzles, as the actual measurement value indicating the ejection state of the ink.

8. The printing apparatus according to claim 1, wherein different operation is performed for each ink in the maintenance operation.

9. The printing apparatus according to claim 1, wherein the first threshold value is set as a common value for all of the inks, and the second threshold value is set as different values for each ink.

10. The printing apparatus according to claim 9, wherein the first threshold value is a threshold value which distinguishes between a clogged state and an unstable ejection state, and the second threshold value is a threshold value which distinguishes between a an unstable ejection state and a normal state.

11. A maintenance method for a printing apparatus comprising:
measuring an actual measurement value indicating an ejection state of ink ejected from nozzles;
comparing the actual measurement value with a first threshold value and a second threshold value which are set for each ink color to determine which is the ejection state of the ink among three states of a normal state, a clogged state, and an unstable ejection state between the normal state and the clogged state, which are distinguished by the first threshold value and the second threshold value; and
performing different maintenance operations in accordance with a determination result.
